(19) United States
(12) Patent Application Publication
(10) Pub. No.: US 2012/0295582 A1
(43) Pub. Date: Nov. 22, 2012

(54) RESTRICTION OF SERVICES FOR COMMUNICATION TERMINALS TO DIRECTED NUMBERS

(75) Inventors: Tommy Olofsson, Ramdala (SE); Magnus Svensson, Karlskrona (SE)

(73) Assignee: Telefonaktiebolaget L M Ericsson (publ), Stockholm (SE)

(21) Appl. No.: 13/110,490

(22) Filed: May 18, 2011

(51) Int. Cl. H04W 4/24; H04W 12/00

(52) U.S. Cl. 455/406; 455/411

(57) ABSTRACT

A network node of a cost charging system authorizes communication services provided to communication terminals in a telecommunications system. The network node receives a communication service request from a communications terminal. The network node determines that a subscriber account associated with the communications terminal has entered a limited service mode. The network node responds to the receipt of the communication service request and to the determination by authorizing the requested communication service in a restricted direct access mode for the subscriber account based on the requested communication service being directed to a telephone number that is among at least one subscriber defined telephone number in the subscriber account. Related methods, home location registers, and systems are disclosed.

### TECHNICAL FIELD

The present disclosure is directed to network communications and, more particularly, to controlling services provided to communication terminals.

### BACKGROUND

Prepaid call services are a rapidly growing segment in the telecommunications industry. As the name implies, a prepaid call service allows a user to pay in advance for the use of a provider's network resources, such as for telephone calls and messaging (e.g., Short Message Service, Multimedia Messaging Service, etc.) from a wireless communication terminal. The prepaid call service provides, among other things, an alternative option for a user who does not want to be contractually bound to a service provider for postpaid services or who might not be able to obtain postpaid services because of, for example, a bad credit rating.

In a prepaid voice scenario, as part of the establishment of a telephone call, a home location register database is queried for the location of a caller's service account to verify that the account is active (i.e., not expired) and, if active, to further determine by reference to the service account if there is at least a threshold amount of funds available to pay for a call about to be made. The ultimate cost of the desired telephone call is not known at that time, because the caller may not know the exact length of time that they would like to speak. Thus, a ‘minimum’ cost of the telephone call given the location of the called party (e.g., for a 3 minute call) may be determined, and compared to the remaining balance in the caller's service account. If the service account is active and has sufficient money remaining to pay for at least the minimum cost of the telephone call (e.g., to pay for a minimum 3 minute call), the call is allowed to go through and be established. However, when the service account has expired or has insufficient funds, the system blocks the call from being established.

Similar restrictions on services can be provided on post-paid accounts. For example, a service account may define a maximum number of minutes that can be used and/or a maximum number of messages that can be sent/received each month. When a limit is reached, the system blocks further calls or messages.

It has become commonplace for each member of a family to have a wireless communication terminal. Children are oftentimes provided with terminals linked to prepaid account services or to postpaid accounts that have defined limits on talk minutes and/or messaging. Using prepaid accounts or postpaid accounts with service limits is useful as a tool to control costs, however once the account expires, has insufficient funds, or a maximum talk time or maximum number of messages is reached, incoming and outgoing calls/messages are blocked. As an example, this denial of service may be particularly problematic when a parent can no longer reach a child and vice versa.

### SUMMARY

Some embodiments of the present invention are directed to a method of authorizing communication services provided to communication terminals in a telecommunications system. A communication service request is received that is from or directed to a communications terminal. A determination is made that a subscriber account associated with the communications terminal has entered a limited service mode. In response to the receipt of the service request and to the determination, the requested service is authorized in a restricted direct access mode for the subscriber account triggered by the requested service being directed to a subscriber identity that is among at least one subscriber defined identity in the subscriber account.

Accordingly, when the limited service mode is active, the requested service is authorized if it is directed to a subscriber identity that is listed in the subscriber's account, otherwise the requested service may be denied. The method may further include determining that the subscriber account has entered the limited service mode when the account has expired, has insufficient funds, has reached a threshold limit on talk time and/or messages sent and/or received, or has otherwise transitioned to a passive state.

Some other embodiments are directed to a network node of a cost charging system that authorizes communication services provided to communication terminals in a telecommunications system. The network node is configured to receive a communication service request that is from or directed to a communications terminal. The network node determines that a subscriber account associated with the communications terminal has entered a limited service mode. The network node responds to the receipt of the communication service request and to the determination by authorizing the requested communication service in a restricted direct access mode for the subscriber account triggered by the requested communication service being directed to a subscriber identity that is among at least one subscriber defined identity in the subscriber account. The network node may be a service data point of the cost charging system.

Some other embodiments are directed to a home location register for use in a telecommunications system. The home location register is configured to store at least one subscriber defined identity as at least one record associated with a subscriber account, and to respond to a command from a network node of a cost charging system to activate a restricted direct access mode for the subscriber account by setting a mode status record associated with the subscriber account to an active indication. While the status record is set to the active indication, communication services for a communications terminal associated with the subscriber account are limited based on the communications services being directed to the at least one subscriber defined identity stored as the at least one record.

Other network nodes, systems, home location registers, and/or methods according to embodiments of the invention will be or become apparent to one with skill in the art upon review of the following drawings and detailed description. It is intended that all such additional network nodes, systems, home location registers, and/or methods be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are incorporated in and constitute a part of this specification, illustrate various embodiments of the invention. In the drawings:

FIG. 1 illustrates a telecommunications system that includes a charging system that authorizes communications services provided by the telecommunication system to communication terminals, and is configured to operate in accordance with some embodiments;

FIG. 2 further illustrates the charging system of FIG. 1 and a home location register that stores subscriber account records, and which provide a restricted direct access mode for communication terminals in accordance with some embodiments;

FIG. 3 further illustrates operations and methods of the charging system and home location register of FIG. 2 that respond to expiration of subscriber account by providing a restricted direct access mode for communication terminals in accordance with some embodiments;

FIGS. 4 and 5 illustrate subscriber data records and supplementary service data records in the home location register of FIG. 2, and which are configured to provide a restricted direct access mode for communication terminals in accordance with some embodiments;

FIG. 6 further illustrates operations and methods of the charging system and home location register of FIG. 2 that respond to insufficient funds and/or a maximum talk time being reached by providing a restricted direct access mode for communication terminals in accordance with some embodiments;

FIG. 7 is a signaling diagram that illustrates operations and associated message flows performed by network nodes to provide a restricted direct access mode for communication terminals in accordance with some embodiments;

FIGS. 8-10 illustrate flowcharts of operations and methods that provide a restricted direct access mode for a communication terminal in accordance with some embodiments; and

FIG. 11 is a block diagram of network node in accordance with some embodiments.

### DETAILED DESCRIPTION

In the following description, for purposes of explanation and not limitation, specific details are set forth such as particular architectures, interfaces, operations, methods, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, operations, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

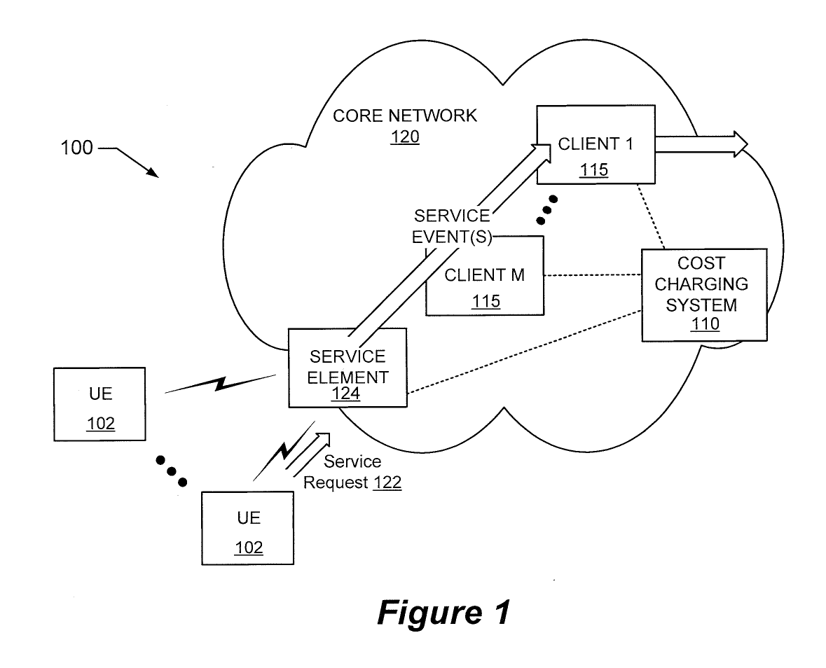

FIG. 1 illustrates a telecommunications system 100 that includes a cost charging system 110 that authorizes communications services provided by a core network 120 to user equipment units (UEs) 102 according to some embodiments. A UE 102 may generate a service request 122, such as by attempting to the place telephone call and/or attempting to send a message (e.g., Short Message Service, Multimedia Messaging Service, etc.). A service element 124 of the core network 120 provides network service to the UEs 102, and can respond to the service request 122 by sending a charging request to the charging system 110 that can selectively authorized or denied by the charging system 110.

As part of the provisioning of a subscriber, a Home Location Register (HLR) is initiated with Direct Number Access System (DNAS) numbers that can be accessed (e.g., calling, texting, sending email, etc.) by a subscriber when the subscriber is blocked from accessing other numbers. This Direct Number Access (DNA) feature is inactive in the normal situation when the subscriber is not blocked from accessing numbers.

Although various embodiments are described in the context of identifying a terminal by a number (e.g., telephone number), the invention is not limited thereto. In some other embodiments, a direct access mode can be provided that lists any type of information that can be used to identify a particular terminal for originating or terminating a service. The information may include, but is not limited to International Mobile Subscriber Identities (IMSI), Mobile Station International Subscriber Directory Number (MSISDN), Network Access Identifier (NAI), PRIVATE, and/or Session Initiation Protocol (SIP) Uniform Resource Identifier (URI).

The charging system 110 contains a subscriber account associated with each of the UEs 102. In response to the charging request, the charging system 110 determines whether the subscriber account associated with the requesting UE 102 has entered a limited service mode. The limited service mode may be caused by the subscriber account expiring (e.g. the present date is beyond an expiration date of a prepaid account), having insufficient funds for the service request 122, and/or having reached a threshold limit on talk time and/or number of messages sent and/or received (e.g., a postpaid account having a defined limit on talk time and/or number of messages that can be sent and/or received in each billing cycle), or caused by another event that triggers transition of the account to a passive state.

When a subscriber has reached a service limit (e.g., insufficient funds or inactive account), the charging system 110 sends a signal to the HLR to cause activation of the DNA numbers. While the subscriber's account is at the service limit (e.g., subscribers has not refilled or reactivated the account) and the subscribers attempts to make a call to a number, the service element determines that the account is blocked. A determination is then made whether the DNA numbers are active and, if so, a further determination is made whether the called number is one of the DNA numbers in the HLR. The call is allowed if the called number is one of the DNA numbers.

By example, if the service element 124 (e.g. MSC) determined that the restricted direct access mode is authorized by the subscriber account and, if so, authorize the service request 122 if the service request 122 is directed to a telephone number that is among at least one subscriber defined telephone number in the subscriber account. However, while the subscriber's account has reached the service limit, other service requests that are directed to telephone numbers that are not among the subscriber defined telephone number(s) in the subscriber account may be blocked, except in some situations where the service request is directed to an emergency telephone number for which services are allowed irrespective of the subscriber's account status.

By further example, the subscriber may define one or more telephone numbers that are stored in the subscriber's account in the HLR 210. The defined telephone numbers may correspond to the subscriber's family members, such as parents, children, and/or siblings. When the subscriber's account is a prepaid account that has expired and/or has insufficient remaining funds and/or when the subscriber's account is a postpaid account that has reached a threshold limit on talk time and/or the number of messages that are allowed to be sent and/or received and a billing cycle, the HLR 210 authorizes a service request 122 for a telephone call or a message to be completed through the core network 120 if it is directed to a telephone number that is among the defined telephone number(s) in the subscriber's account. Otherwise, if the telephone call or the message is directed to a telephone number outside the defined telephone number(s), the HLR 210 denies the service request 122 to block the telephone call from being established or the message from being communicated through the core network 120, unless if the telephone call and/or the message is directed to a national emergency telephone number for which services are normally allowed irrespective of a subscriber's account status.

The authorization/denial decision by the charging system 110 is communicated to the service element 124. The service element 124 establishes the telephone call or communicates the message as a service event through the core network 120 when the service request 122 is authorized, and does not establish the telephone call or communicate the message through the core network when the service request 122 is denied.

The network 120 also includes clients 115 that act as intermediate devices for handling a service event. A client 115 can also receive a service request from another device which is directed to one of the UEs 102 (e.g., a telephone call or message by a device over the public switched telephone network or private/public packet network). Each of clients 115 may include a credit-control client that interacts with the charging system 110. The charging system 110 can similarly respond to a service request from one of the clients 115 that is directed to one of the UEs 102 by determining whether the subscriber account associated with the destination UE 102 has reached a service limit. If the service limit has been reached, the charging system 110 may then further determine if a restricted direct access mode is authorized for the destination UE 102 and, if so, authorize the service request if the service request is originating from a telephone number (e.g., calling number) of the device that is among at least one subscriber defined telephone number in the subscriber account for the destination UE 102. Otherwise, if the telephone call or message is originating from a telephone number that is outside the defined telephone number(s), the charging system 110 denies the service request. The authorization/denial decision by the charging system 110 is communicated to the requesting client 115. The requesting client 115 establishes the telephone call or communicates the message as a service event through the core network 120 and service element 124 when the service request is authorized, and does not establish the telephone call or communicate the message through the core network when the service request is denied.

The service element 124 and a client 115 may be combined into a single network node, and may act as a credit-control client. Examples of a service element 124 may include, but are not limited to, a mobile switching center (MSC), a network access server (NAS), a SIP proxy server, a Serving General Packet Radio Service (GPRS) Support Node (SGSN), a GPRS node, or an Application server, such as, for example, a messaging server.

Each of UEs 102 may be a cellular radiotelephone, a personal digital assistant (PDA), a Personal Communications Systems (PCS) terminal, a laptop computer, a desktop computer, a palmtop computer, tablet computer, or any other indications terminal that includes a communication transceiver that permits the device to communicate with other devices.

Network 120 may include one or more networks of any type, including a local area network (LAN); a wide area network (WAN); a metropolitan area network (MAN); a telephone network, such as a Public Switched Telephone Network (PSTN) or a Public Land Mobile Network (PLMN); a satellite network; an intranet, the Internet; or a combination of these and/or other types of networks. The PLMN(s) may further include a packet-switched sub-network, such as, for example, General Packet Radio Service (GPRS), Cellular Digital Packet Data (CDPD), a Mobile Internet Protocol (IP) network, or an IMS network.

It will be appreciated that the components illustrated in FIG. 1 are shown by way of example. Other configurations with more components, fewer components, different components, or a different arrangement of components may be implemented. Moreover, in some embodiments, one or more components in FIG. 1 may perform one or more of the tasks described as being performed by one or more other components in FIG. 1.

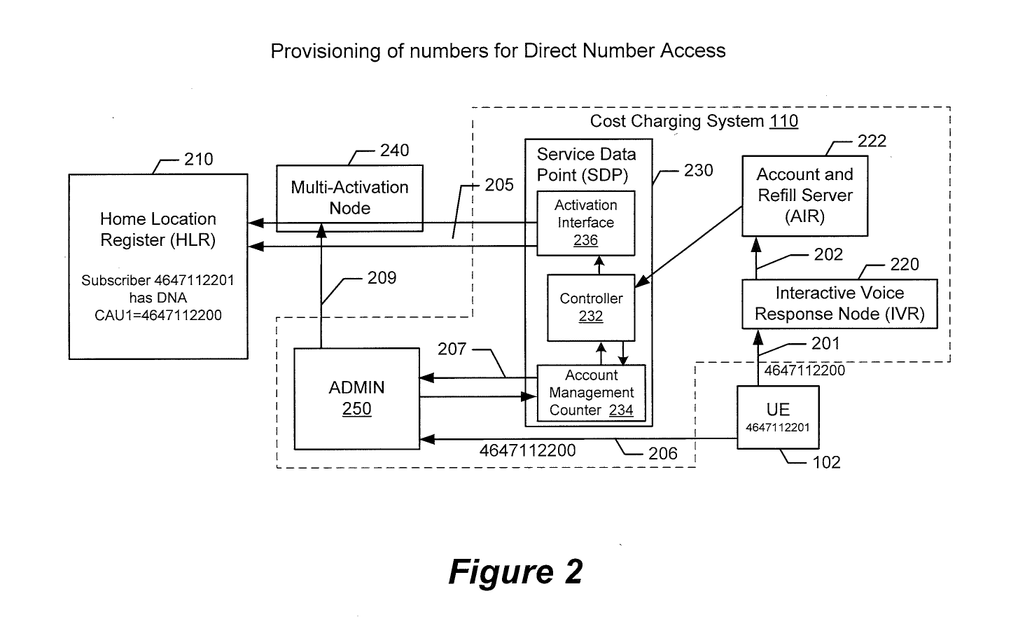

FIG. 2 further illustrates the charging system 110 of FIG. 1 and a home location register (HLR) 210 that stores subscriber account records. The charging system 110 and HLR 210 provide a restricted direct access mode for communication terminals in accordance with some embodiments. To setup a restricted direct access mode, a subscriber of a UE 102 (e.g., telephone no. 4647112201) may interface with the cost charging system 100 through a customer care agent at an administration node (Admin) 250 and/or through an interactive voice/data response node (IVR) 220.

The subscriber may contact (206) the administration node 250 via a self care interface as for example customer support or web based self service node to activate/deactivate the restricted direct access mode and to define at least one telephone number (e.g., 4647112200) of another UE 102 or other communication terminal with which directed number access mode will allow service to be established while the subscriber's account has reached a service limit. The administrative node 250 causes (signaling 207) a controller 232 in the service data point (SDP) 230 to update (signaling 205) the subscriber's account in the HLR 210 with the status (active/inactive) of the restricted direct access mode and the subscriber defined at least one telephone number.

Alternatively or additionally, subscriber may call (201) or otherwise establish a data interface with the interactive voice/data response node (IVR) 220 to activate/deactivate the restricted direct access mode and to define at least one telephone number (e.g., 4647112200) of another UE 102 or other communication terminal with which directed number access mode will allow service to be established while the subscriber's account has reached a service limit. The IVR 220 may provide voice prompts through which a subscriber may activate or deactivate the restricted direct access mode, and enter the one or more telephone numbers (e.g., 4647112200). The IVR 220 can interface (signal 202) through an account and refill server (AIR) 222 and the controller 232 to access information in the subscriber account and to update the subscriber account and HLR 210.

Accordingly, after being updated as shown in FIG. 2, the subscriber's account can include information identifying the subscriber's UE telephone number (e.g. 4647112201), an active restricted direct access mode (e.g., DNA), and a list of the subscriber defined telephone numbers (e.g. call access number (CAU) 4647112200) to which telephone calls and/or messages may be directed to and/or received from while the user's account has reached a service limit.

During the setup process, the administrative node 250 and/or the IVR 228 determine that the number access mode is authorized for the subscriber, and may further determine whether any constraints on how many telephone numbers can be entered, how often the listed telephone numbers can be changed, and/or other constraints (e.g., prohibit international telephone numbers from being entered, prohibit telephone numbers outside the subscriber's local calling area from being entered, and/or prohibit telephone numbers outside a defined set of defined telephone numbers from being entered) that are used by the service data point 230 to regulate whether the subscriber can enter telephone numbers and to regulate what telephone numbers can be entered by the subscriber for use in the restricted direct access mode.

The service data point 230 may communicate with the HLR 210 through a multi-activation node 240 that may provide an interoperability interface between the service data point 230 and HLRs 210 from different vendors. The controller 232 of the service data point 230 may communicate with the HLR 210 through an activation interface 236 using for example SS7 (Signaling System 7), CIP/IP or SIGTRAN as a signaling interface.

The service data point 230 includes an account management counter 234 that tracks usage of services by a UE 102, such as by decrementing/incrementing a minute counter responsive to an ongoing telephone call, and/or by incrementing/decrementing an outgoing message counter and/or an incoming message counter responsive to messages being sent from and/or to the UE 102.

A controller 232 of the service data point 230 responds to a charging request, such as from the service element 124 and/or the client 115 (FIG. 1), by determining whether the subscriber account associated with the UE 102 making the service request has reach a service limit. For example, the controller 232 may query the HLR to determine whether the subscriber account is active or expired, and further determine from the account management counter 234 and/or from the HLR 210 whether the subscriber account has insufficient funds and/or has reached a threshold limit on talk time and/or messages that can be sent and/or received.

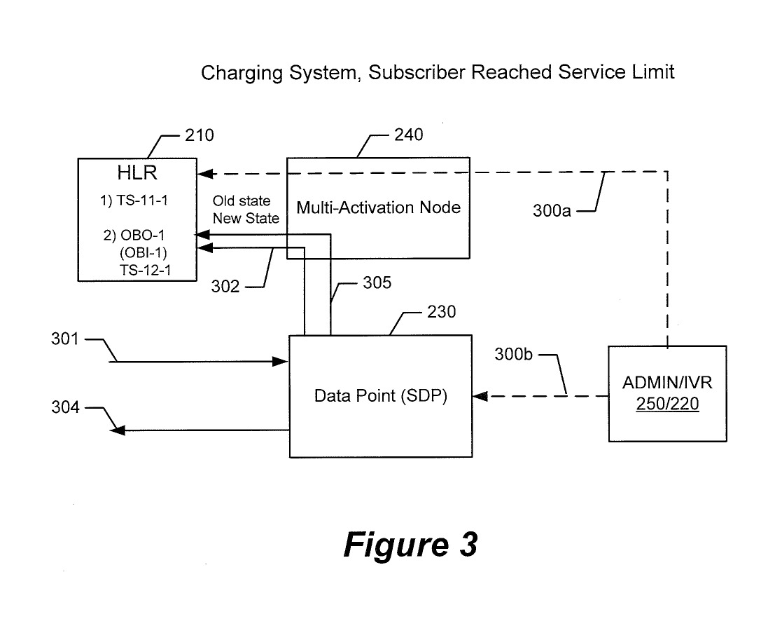

FIG. 3 further illustrates operations and methods of the cost charging system 110 and HLR 210 of FIG. 2 that respond to expiration of subscriber account by providing restricted services for a UE 102 through a restricted direct access mode in accordance with some embodiments.

The service data point 230 responds to an indication (signal 301) that the subscriber's account has expired (e.g., an expiration date for existing funds in the subscriber account has passed) by sending a request (signal 302) to the HLR 210 to block further services from being authorized for the UE 102 associated with the subscriber account.

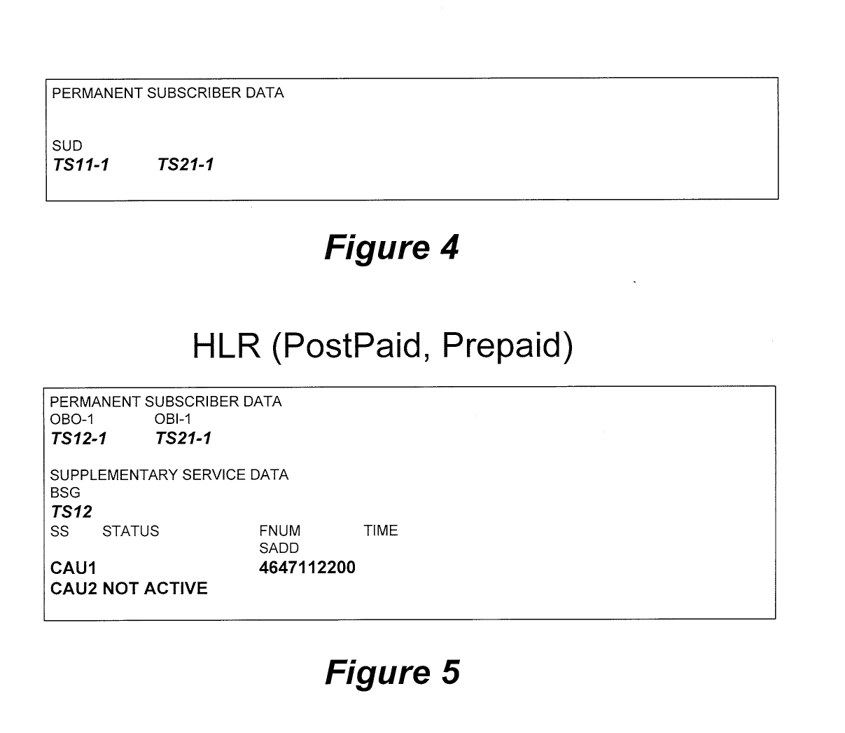

FIG. 4 illustrates example subscriber data records in the HLR 210 of FIG. 2 for the subscriber account associated with the UE 102 (e.g., telephone number 464711201). When the subscriber attempts to make a speech call, the HLR 210 determines whether a TeleServices (TS) 11 record is present in the subscriber data records that authorizes the speech call to be setup. The HLR 210 allows the subscriber to send a short message service (SMS) message if a TS 22 record is present in the subscriber data records, and allows the subscriber to receive a SMS message if a TS 21 record is present in the subscriber data records. TeleServices records are known to those of skill in the art and are further explained in the 3GPP specification (e.g., www.3gpp.org/ftp/specs/html-info/22003.htm). The subscriber data records can further include an Operator Barring of Outgoing (OBO) record that indicates whether outgoing calls are authorized and an Operator Barring of Incoming (OBI) record that indicates whether incoming calls are authorized. In response to the request (signal 302) the HLR 210 can update the OBO record and the OBI record to block outgoing and incoming calls to the UE 102 associated with the subscriber account.

Accordingly, once the subscriber account has expired all incoming and outgoing calls can be blocked. However, in accordance with some embodiments, the subscriber account may be enabled to use a restricted direct access mode during which telephone calls and/or messages may be directed to and/or received from other UEs 102, or other communication terminals, having telephone numbers that are within a list defined by the subscriber's account.

As explained above, the administrative node 250 and/or the IVR 220 may be used to set records, via signals 300a/300b, in the HLR 210 to indicate whether the restricted direct access mode for the subscriber account is active or inactive, and to store at least one subscriber defined telephone number in the HLR 210 to which telephone calls and/or messages may be directed to and/or received from while the user's account is at the service limit.

FIG. 5 illustrates example records in the HLR 210 for the subscriber account associated with the UE 102 (e.g., telephone number 464711201), and which have been set to define an activate state for the restricted direct access mode for a defined telephone number. The subscriber, through the administrative node 250 and/or the IVR 220, has set records in the supplementary service data of the HLR 210 to indicate that the restricted direct access mode is active for a single subscriber defined call access number CAU1 (4647112200) stored therein and to set another record to indicate that the restricted direct access mode is “Not Active” for another call access number CAU2.

With continuing reference to FIG. 3, when the subscriber account has expired and the restricted direct access mode is active, the service data point 230 can transmit a request (signal 305) to the HLR 210 to change the TS11 record (telephony) into a TS12 record. The TS12 record is associated with emergency calls and, therefore, overrides the OBO and OBI records so that instead of subscriber account queries returning an instruction to block all outgoing/incoming calls, the supplementary service data records are referenced to determine whether the restricted direct access mode is active for the telephone number that the subscriber is attempting to call (called number) or for the telephone number that is attempting to call the subscriber (caller number). When the subscriber's call is handled using a TS12 record associated with emergency calls, the call may be provided priority handling through the network and services for determining the position of the UE may be activated.

For example, when the subscriber has generated a request to call access number CAU1 (4647112200), the service data point 230 will determine from the supplementary service data records in the HLR 210 that the restricted direct access mode is active for that telephone number, and will therefore output a service authorization message (signal 304) that causes the telephone call to be established (which may be made as a toll free call or as a post-paid or other charged call). In contrast, when the subscriber has requested service to the other call access number CAU2 or to another telephone number, the service data point 230 will determine from the supplementary service data records in the HLR 210 that the restricted direct access mode is not active or is otherwise blocked, and will therefore output a service denial message (signal 304) to cause the telephone call to be blocked. Accordingly, although the subscriber account has reached a service limit (e.g., expired customer account), the subscriber may still make calls to telephone numbers that are listed in the HLR 210 since the subscriber account as being active in the restricted direct access mode.

The service data point 230 responds to a subsequent determination that the account is no longer expired (e.g., subscriber has reactivated the account) by communicating a request to the HLR 210 to replace the TS 12 permanent subscriber data record with the TS 11 permanent subscriber data record. When the account is no longer expired the cease of OBO and/or OBI records will be done by the service data point 230 and subscriber will have normal services and DNA service is deactivated in HLR 210.The service data point 230 may similarly control messaging services using a restricted direct access mode. When the subscriber account has expired and the restricted direct access mode is active, the service data point 230 can transmit a request (signal 305) to the HLR 210 to change the TS 21 (UE originated message) permanent subscriber data record and/or TS 22 (UE terminated message) permanent subscriber data into at least one other number TS permanent subscriber data record to restrict messaging services based on the at least one other number TS permanent subscriber data record. The at least one other number TS permanent subscriber data record, when set, causes subscriber account queries to trigger a determination as to whether the restricted direct access mode is active for the telephone number to which the UE originated message is directed and/or for the telephone number from which the UE terminated messaged originated.

For example, when the subscriber has requested a message service to number CAU1 (4647112200) (UE originated message) or when another UE 102 or other communication terminal associated with number CAU1 has requested a message service to the subscriber's UE 102 (UE terminated message), the service data point 230 will determine from the supplementary service data records in the HLR 210 that the restricted direct access mode is active for that number, and will therefore output a service authorization message (signal 304) to cause the message to be transmitted. In contrast, when the message service is directed to the other number CAU2 or to another telephone number, the service data point 230 will determine from the supplementary service data records in the HLR 210 that the restricted direct access mode is not active or otherwise blocked, and will therefore output a service denial message (signal 304) to cause the message to be blocked. Accordingly, the subscriber may still send messages to restricted direct access mode activated telephone numbers that are listed in the subscriber account and/or receive messages from those telephone numbers although the subscriber account has reached a service limit (e.g., service account has expired).

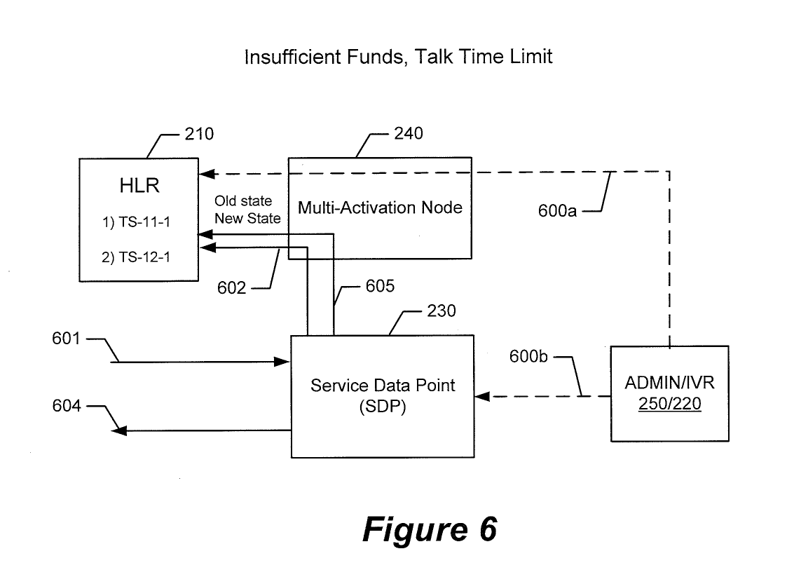

FIG. 6 further illustrates operations and methods of the cost charging system 110 and HLR 210 of FIG. 2 that respond to insufficient funds and/or a talk time limit has been reached by providing a restricted direct access mode for a UE 102 in accordance with some embodiments. The service data point 230 responds to an indication (signal 601) that the subscriber's account has insufficient funds and/or that a talk time limit has been reached (e.g., determined from the account management counter 234) by transmitting a request (signal 602) to the HLR 210 to change the change the TS11 record (FIG. 3) to a TS12 record (FIG. 4).

The TS 12 record is associated with emergency calls and, therefore, causes the supplementary service data records to be referenced to determine whether the restricted direct access mode is active for the telephone number that the subscriber is attempting to call or for the telephone number of the terminal that is attempting to call the subscriber.

For example, when the subscriber has requested call service to call access number CAU1 (4647112200), the service data point 230 will determine from the supplementary service data records in the HLR 210 (signaling 605) that the restricted direct access mode is active for that telephone number, and will therefore output a service authorization message (signal 604) to cause the telephone call to be established (which may be made as a toll free call or as a post-paid or other charged call). In contrast, when the subscriber has requested call service to the other call access number CAU2 or to another telephone number, the service data point 230 will determine from the supplementary service data records in the HLR 210 that the restricted direct access mode is not active or is otherwise blocked, and will therefore output a service denial message (signal 604) to cause the telephone call to be blocked. Accordingly, although the subscriber account has reached a service limit (e.g., insufficient funds and/or a talk time limit has been reached), the subscriber may still make calls to telephone numbers that are listed as being restricted direct access mode active in the subscriber account.

The service data point 230 responds to a subsequent determination that the account no longer has insufficient funds and the talk time limit is no longer reached (e.g., subscriber has added funds to the account and/or has reset or extended the talk time limit) by communicating a request to the HLR 210 to replace the TS 12 permanent subscriber data record with the TS 11 permanent subscriber data record to cease restricting telephone calls to the at least one subscriber defined telephone number (and to any emergency numbers that may be allowed). If the OBO record and/or OBI records have been set to block outgoing and/or incoming calls, those records may also be reset to allow unrestricted calls beyond the direct number access activated number CAU1 (4647112200) listed in the subscriber's account.

The service data point 230 may similarly control messaging services using a restricted direct access mode, as explained above, so that the subscriber's UE 201 can send messages to restricted direct access mode activated telephone numbers and/or can receive messages from those telephone numbers although the subscriber account has reached a service limit (e.g., insufficient funds and/or an incoming/outgoing message limit has been reached).

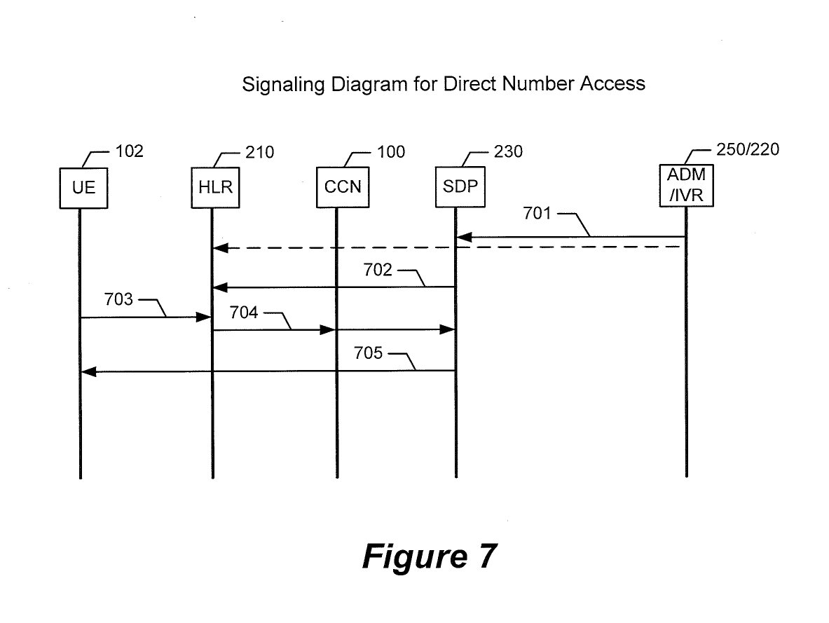

FIG. 7 is a signaling diagram that illustrates an overview of further operations and associated message flows performed by various network nodes to provide a restricted direct access mode for the UEs 102 or other communication terminals in accordance with some embodiments. As explained above, a subscriber can interface through the administrative node 250 and/or through the interactive voice/data response node (IVR) 220 to activate (signal 701) the restricted direct access mode and to define one or more telephone numbers for which communication services are authorized when the restricted direct access mode is active. The dashed line between the ADM/IVR 250/220 and the HLR 210 indicates that the subscriber's request to activate the restricted direct access mode and/or to define one or more telephone numbers (or other identifiers) has been blocked, such as due to the service data point 230 determining a violation would occur in one or more constraints on how many telephone numbers can be entered into the subscriber's account, how often the listed telephone numbers can be changed, and/or other constraints (e.g., prohibit international telephone numbers from being entered, prohibit telephone numbers outside the subscriber's local calling area from being entered, and/or prohibit telephone numbers outside a defined set of defined telephone numbers from being entered) that are used by the service data point 230 to regulate whether the subscriber can enter telephone numbers and to regulate what telephone numbers can be entered by the subscriber for use in the restricted direct access mode.

When the service data point 230 determines that a subscriber account has entered a limited service mode, such as by determining that the subscriber account has expired, has insufficient funds, and/or has reached a threshold limit on talk time and/or messages sent and/or received, or otherwise placed in a passive state, the service data point 230 sends a request (signal 702) to the HLR 210 to change records in the subscriber's account to cause further communication service requests relating to the subscriber's account to be selectively authorized according to a restricted direct access mode.

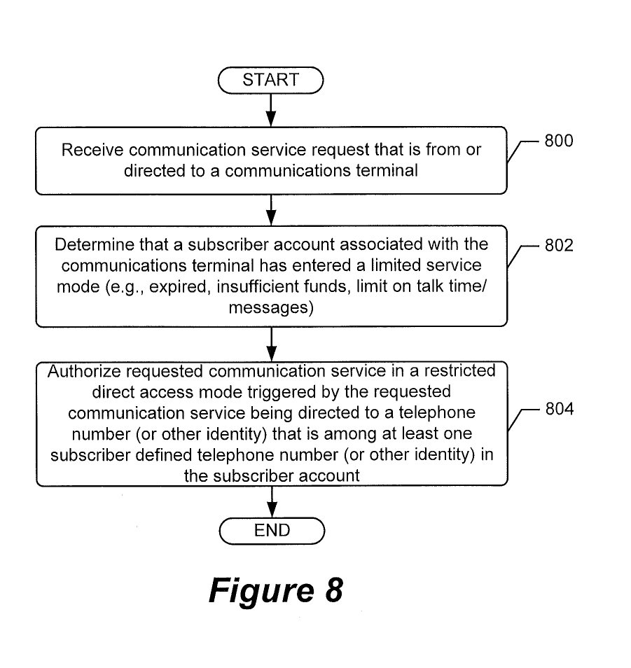

FIG. 8 illustrates a flowchart of operations and methods that provide a restricted direct access mode according to some embodiments. Referring to FIGS. 7 and 8, in response to receiving a communication service request that is from or directed to the UE 102 (e.g., call request or message, signal 703 of FIG. 7 and block 800 of FIG. 8), a determination is made by the service data point 230 of the cost charging system 110 (also called cost control node, CCN) and the HLR 210 as to whether the subscriber count associated with the UE 102 has entered the limited service mode (signal 704 of FIG. 7 and block 802 of FIG. 8). The requested communication service is authorized (signal 705 of FIG. 7 and block 804 of FIG. 8) in a restricted direct access mode based on the requested communication service being directed to a telephone number (or other identity) that is among at least one subscriber defined telephone number (or other identity) in the subscriber account of the HLR 210.

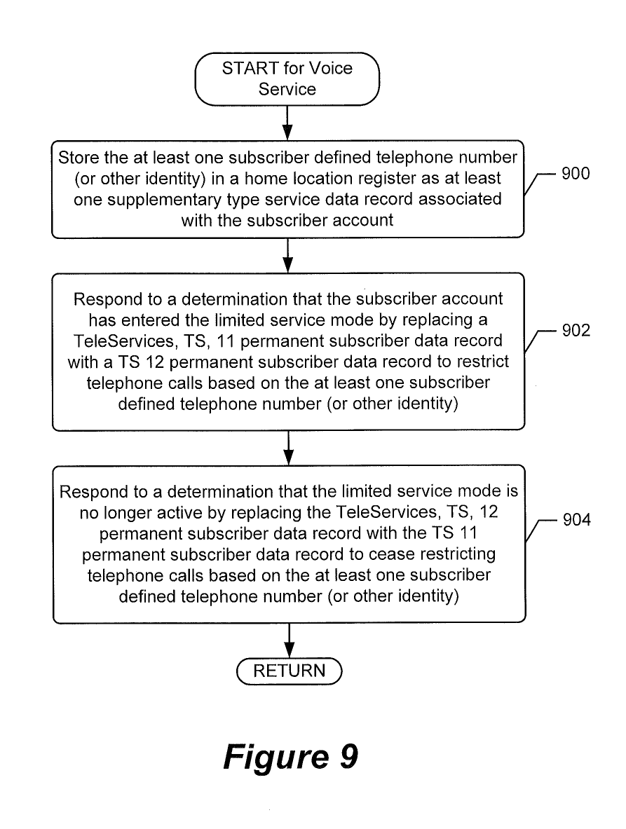

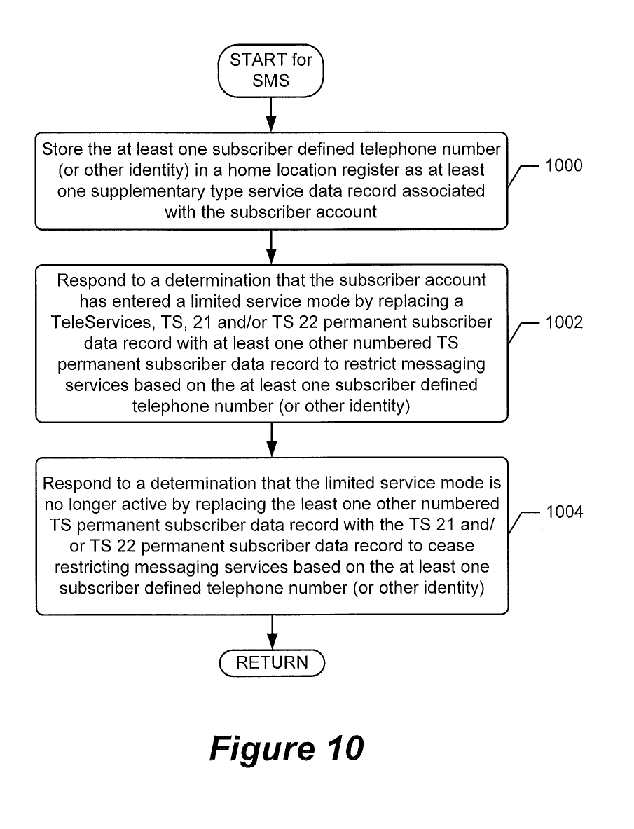

FIGS. 9-10 illustrate flowcharts of other operations and methods that provide a restricted direct access mode for a communication terminal in accordance with some embodiments. Referring to FIG. 9, the HLR 210 stores at least one subscriber defined telephone number (or other identity) as at least one supplementary type service data record associated with the subscriber account (block 900). The service data point 230 or another network node responds to the determination that the subscriber account has entered the limited service mode by replacing a TS 11 permanent subscriber data record with a TS 12 permanent subscriber data record to restrict telephone calls based on the at least one subscriber defined telephone number (block 902). The service data point 230 or another network node responds to a determination that the limited service mode is no longer active by replacing the TS 12 permanent subscriber data record with the TS 11 permanent subscriber data record to cease restricting telephone calls based on the at least one subscriber defined telephone number (block 904).

Referring to FIG. 10, at HLR 210 stores at least one subscriber defined telephone number as at least one supplementary type service data record associated the subscriber account (block 1000). The service data point 230 or another network node responds (block 1002) to the determination that the subscriber account has reached a service limit (e.g., subscriber account has expired, has insufficient funds, and/or has reached a threshold limit on talk time and/or messages sent and/or received) by replacing a TS 21 and/or TS 22 permanent subscriber data record with at least one other numbered TS permanent subscriber data record to restrict messaging services based on the at least one subscriber defined telephone number. The service data point 230 or another network node responds (block 1004) to a determination that the service limit is no longer reached by the subscriber account by replacing the least one other numbered TS permanent subscriber data record with the TS 21 and/or TS 22 permanent subscriber data record to cease restricting messaging services based on the at least one subscriber defined telephone number.

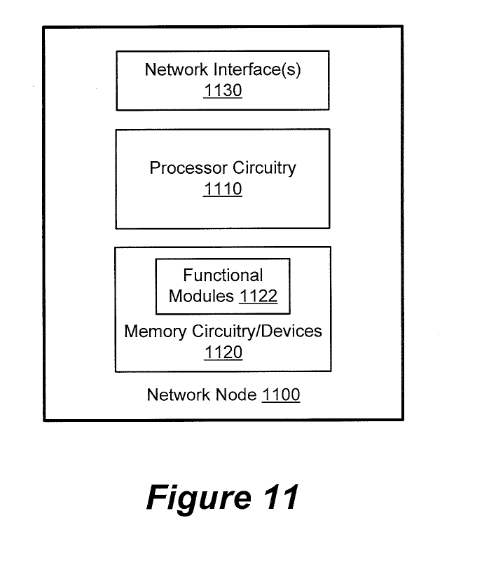

FIG. 11 illustrates a block diagram of a network node 1100 that may be used in the cost charging system 100 and/or the HLR 210 of FIG. 2, and/or in the service element 124 and/or client 115 of FIG. 1, and/or used in other elements illustrated in any of the figures. The network node 1100 can include one or more network interfaces 1130, processor circuitry 1110, and memory circuitry/devices 1120 that contain functional modules 1122.

The processor circuitry 1110 may include one or more data processing circuits, such as a general purpose and/or special purpose processor (e.g., microprocessor and/or digital signal processor). The processor circuitry 1110 is configured to execute computer program instructions from the functional modules 1122 in the memory circuitry/devices 1120, described below as a computer readable medium, to perform some or all of the operations and methods that are described above for one or more of the embodiments, such as the embodiments of FIGS. 1-10. Accordingly, the processor circuitry 1110 can be configured by execution of the computer program instructions in the functional modules 1122 to carry out at least some of the functionality described herein.

Some methods that carried out by one or more of the network nodes 1100 authorize communication services provided to communication terminals in a telecommunications system. A communication service request is received from a communications terminal. A determination is made that a subscriber account associated with the communications terminal has reached a service limit. In response to the receipt of the service request and to the determination, the requested service is authorized in a restricted direct access mode for the subscriber account based on the requested service being directed to a telephone number that is among at least one subscriber defined telephone number in the subscriber account.

Accordingly, when the service limit is reached, the requested service is authorized if it is directed to a telephone number that is listed in the subscriber's account, otherwise the requested service may be denied.

The method may further include determining that the subscriber account has reached the service limit when the account has expired, has insufficient funds, and/or has reached a threshold limit on talk time and/or messages sent and/or received.

The method may further include receiving the at least one subscriber defined telephone number from a subscriber during a restricted direct access mode setup procedure, and storing the subscriber defined telephone number(s) in a home location register as at least one supplementary type service data record associated with the subscriber account. In response to the subscriber account been determined to have reached the service limit, a defined permanent subscriber data record associated with the subscriber account is replaced with another data record that triggers restriction of communication services based on the at least one subscriber defined telephone number.

The method may further include responding to a command from a charging system to activate the restricted direct access mode for the subscriber account by setting in the home location register a mode status record associated with the subscriber account to an active indication. In response to another command from the charging system to deactivate the restricted direct access mode for the subscriber account, the mode status record is set to an inactive indication. Replacement of the defined permanent subscriber data record associated with the subscriber account with the other data record may be allowed when the mode status record is set to the active indication and not allowed when the status record is set to the inactive indication.

The method may further include responding to the determination that the subscriber account has reached the service limit by replacing a TS 11 permanent subscriber data record associated with the subscriber account with a TS 12 permanent subscriber data record to restrict telephone calls based on the at least one subscriber defined telephone number stored as the at least one supplementary type service data record. Following the determination that the subscriber account has reached the service limit, the method may respond to another determination that the service limit is no longer reached by the subscriber account by replacing the TS 12 permanent subscriber data record associated with the subscriber account with a TS 11 permanent subscriber data record to cease restricting telephone calls based on the at least one subscriber defined telephone number stored as the at least one supplementary type service data record.

The method may further include responding to the determination that the subscriber account has reached the service limit by replacing a TS 21 and/or TS 22 subscriber data record associated with the subscriber account with at least one other numbered TS subscriber data record to restrict messaging services from and/or to the communications terminal based on the at least one subscriber defined telephone number stored as the at least one supplementary type service data record. Following the determination that the subscriber account has reached the service limit, the method may include responding to a determination that the service limit is no longer reached by the subscriber account by replacing the at least one other numbered TS subscriber data record associated with the subscriber account with the TS 21 and/or TS 22 subscriber data record to cease restricting messaging services from and/or to the communications terminal based on the at least one subscriber defined telephone number stored as the at least one supplementary type service data record.

When the network node 1100 is configured as a HLR for use in a telecommunications system, the HLR is configured to store at least one subscriber defined telephone number as at least one record associated with a subscriber account, and to respond to a command from a network node of a cost charging system to activate a restricted direct access mode for the subscriber account by setting a mode status record associated with the subscriber account to an active indication. While the status record is set to the active indication, communication services for a communications terminal associated with the subscriber account are limited based on the communications services being directed to the at least one subscriber defined telephone number stored as the at least one record.

The HLR may be further configured to store the at least one subscriber defined telephone number as at least one supplementary type service data record associated with the subscriber account, and to respond to a command from the network node when the subscriber account has reached a service limit by replacing a TS 11 subscriber data record associated with the subscriber account with a TS 12 subscriber data record to restrict telephone calls based on the at least one subscriber defined telephone number stored as the at least one supplementary type service data record.

The HLR may be further configured to respond to another command from the network node when the service limit is no longer reached by the subscriber account by replacing the TS 12 permanent subscriber data record associated with the subscriber account with a TS 11 permanent subscriber data record to cease restricting telephone calls based on the at least one subscriber defined telephone number stored as the at least one supplementary type service data record.

The HLR may be further configured to respond a command from the network node when the subscriber account has reached a service limit by replacing a TS, 21 and/or TS 22 subscriber data record associated with the subscriber account with at least one other numbered TS subscriber data record to restrict messaging services from and/or to the communications terminal based on the at least one subscriber defined telephone number stored as the at least one supplementary type service data record. The HLR may be further configured to respond to another command from the network node that the service limit is no longer reached by the subscriber account by replacing the at least one other numbered TS subscriber data record associated with the subscriber account with the TS 21 and/or TS 22 subscriber data record to cease restricting messaging services from and/or to the communications terminal based on the at least one subscriber defined telephone number stored as the at least one supplementary type service data record.

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Exemplary embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various exemplary combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. A method of authorizing communication services provided to communication terminals in a telecommunications system, the method comprising:
receiving at least one subscriber defined identity from a subscriber during a direct access mode setup procedure;
storing the at least one subscriber defined identity in a home location register as at least one supplementary type service data record associated with the subscriber account;
receiving a communication service request that is from or directed to a communications terminal;
determining that a subscriber account associated with the communications terminal has entered a limited service mode and responding to the determination by replacing a defined permanent subscriber data record associated with the subscriber account in the home location register with another data record that triggers restriction of communication services based on the at least one subscriber defined identity stored as the at least one supplementary type service data record; and
responding to the receipt of the communication service request and the other data record being associated with the subscriber account in the home location register by authorizing the requested communication service in a restricted direct access mode for the subscriber account when the requested communication service is directed to a subscriber identity that is among the at least one subscriber defined identity that has been stored as the at least one supplementary type service data record.

2. The method of claim 1, wherein determining that the subscriber account associated with the communications terminal has entered the limited service mode comprises:
determining that the subscriber account has expired, has insufficient funds, has reached a threshold limit on talk time and/or messages sent and/or received, and/or is in a passive state.

3. (canceled)

4. The method of claim 1, further comprising:
responding to a command from a charging system to activate the restricted direct access mode for the subscriber account by setting in the home location register a mode status record associated with the subscriber account to an active indication; and
responding to another command from the charging system to deactivate the restricted direct access mode for the subscriber account by setting the mode status record to an inactive indication,
wherein replacement of the defined permanent subscriber data record associated with the subscriber account with the other data record is allowed when the mode status record is set to the active indication and is not allowed when the status record is set to the inactive indication.

5. The method of claim 1, further comprising:
responding to the determination that the subscriber account has entered the limited service mode by replacing a first TeleServices, TS, permanent subscriber data record associated with the subscriber account in the home location register with a second TS permanent subscriber data record in the home location register to restrict telephone calls based on the at least one subscriber defined identity stored as the at least one supplementary type service data record in the home location register.

6. The method of claim 5, wherein:
the second TS permanent subscriber data record causes telephone calls that are from or directed to the communications terminal to be handled as emergency calls by the telecommunications system.

7. The method of claim 6, wherein:
the first TS permanent subscriber data record is TS 11; and
the second TS permanent subscriber data record is TS 12.

8. The method of claim 1, further comprising:
responding to the determination that the subscriber account has entered the limited service mode by replacing a TeleServices, TS, 21 and/or TS 22 permanent subscriber data record associated with the subscriber account with at least one other numbered TS permanent subscriber data record to restrict messaging services from and/or to the communications terminal based on the at least one subscriber defined identity stored as the at least one supplementary type service data record.

9. A network node of a cost charging system that authorizes communication services provided to communication terminals in a telecommunications system, the network node is configured to:
receive at least one subscriber defined identity from a subscriber during a direct access mode setup procedure;
store the at least one subscriber defined identity in a home location register as at least one supplementary type service data record associated with the subscriber account;
receive a communication service request that is from or directed to a communications terminal;
determine that a subscriber account associated with the communications terminal has entered a limited service mode and respond to the determination by replacing a defined permanent subscriber data record associated with the subscriber account in the home location register with another data record that triggers restriction of communication services based on the at least one subscriber defined identity stored as the at least one supplementary type service data record; and
respond to the receipt of the communication service request and the other data record being associated with the subscriber account in the home location register by authorizing the requested communication service in a restricted direct access mode for the subscriber account when the requested communication service is directed to a subscriber identity that is among the at least one subscriber defined identity that has been stored as the at least one supplementary type service data record.

10. The network node of claim 9, further configured to determine that the subscriber account associated with the communications terminal has entered the limited service mode by:
determining that the subscriber account has expired, has insufficient funds, has reached a threshold limit on talk time and/or messages sent and/or received, and/or is in a passive state.

11. (canceled)

12. The network node of claim 9, further configured to:
activate the restricted direct access mode for the subscriber account by setting in the home location register a mode status record associated with the subscriber account to an active indication;
deactivate the restricted direct access mode for the subscriber account by setting the mode status record to an inactive indication; and
replace the defined permanent subscriber data record associated with the subscriber account with the other data record when the mode status record is set to the active indication, and not replace the defined permanent subscriber data record with the other data record when the mode status record is set to the inactive indication.

13. The network node of claim 9, further configured to:
following the determination that the subscriber account has entered the limited service mode by replacing a first TeleServices, TS, permanent subscriber data record in the home location register associated with the subscriber account with a second TS permanent subscriber data record in the home location register to restrict telephone calls based on the at least one subscriber defined identity stored as the at least one supplementary type service data record in the home location register.

14. The network node of claim 13, wherein:
the second TS permanent subscriber data record causes telephone calls that are from or directed to the communications terminal to be handled as emergency calls by the telecommunications system.

15. The network node of claim 14, wherein:
the first TS permanent subscriber data record is TS 11; and
the second TS permanent subscriber data record is TS 12.

16. The network node of claim 9, further configured to:
respond to the determination that the subscriber account has entered the limited service mode by replacing a TeleServices, TS, 21 and/or TS 22 permanent subscriber data record associated with the subscriber account with at least one other numbered TS permanent subscriber data record to restrict messaging services from and/or to the communications terminal based on the at least one subscriber defined identity stored as the at least one supplementary type service data record.

17. A home location register for use in a telecommunications system, the home location register is configured to:
store at least one subscriber defined identity as at least one record associated with a subscriber account; and
respond to a command from a network node of a cost charging system to activate a restricted direct access mode for the subscriber account by setting a mode status record associated with the subscriber account to an active indication, wherein while the status record is set to the active indication, communication services for a communications terminal associated with the subscriber account are limited based on the communications services being directed to the at least one subscriber defined identity stored as the at least one record.

18. The home location register of claim 17, further configured to:
store the at least one subscriber defined identity as at least one supplementary type service data record associated with the subscriber account; and
respond to a command from the network node when the subscriber account has entered a limited service mode by replacing a TeleServices, TS, 11 permanent subscriber data record associated with the subscriber account with a TS 12 permanent subscriber data record to restrict telephone calls based on the at least one subscriber defined identity stored as the at least one supplementary type service data record.

19. The home location register of claim 18, further configured to:
respond to another command from the network node when the limited service mode is no longer active by replacing the TS 12 permanent subscriber data record associated with the subscriber account with a TS 11 permanent subscriber data record to cease restricting telephone calls based on the at least one subscriber defined identity stored as the at least one supplementary type service data record.

20. The home location register of claim 17, further configured to:
respond to a command from the network node when the subscriber account has entered a limited service mode by replacing a TeleServices, TS, 21 and/or TS 22 permanent subscriber data record associated with the subscriber account with at least one other numbered TS permanent subscriber data record to restrict messaging services from and/or to the communications terminal based on the at least one subscriber defined identity stored as the at least one supplementary type service data record; and
respond to another command from the network node that the limited service mode is no longer active by replacing the at least one other numbered TS permanent subscriber data record associated with the subscriber account with the TS 21 and/or TS 22 permanent subscriber data record to cease restricting messaging services from and/or to the communications terminal based on the at least one subscriber defined identity stored as the at least one supplementary type service data record.
